(19) United States
(12) Patent Application Publication
(10) Pub. No.: US 2012/0014094 A1
(43) Pub. Date: Jan. 19, 2012

(54) CONNECTION COMPONENT AND BACKLIGHT MODULE

(75) Inventor: Gang Yu, Shenzhen (CN)

(73) Assignee: SHENZHEN CHINA STAR OPTOELECTRONICS TECHNOLOGY CO., LTD., Shenzhen (CN)

(21) Appl. No.: 13/220,270

(22) Filed: Aug. 29, 2011

Related U.S. Application Data
(63) Continuation of application No. PCT/CN2010/079149, filed on Nov. 26, 2010.

(30) Foreign Application Priority Data
Jul. 14, 2010 (CN) 201010230777.9

(51) Int. Cl. G02F 1/13357; F16B 45/00

(52) U.S. Cl. 362/97.2; 24/598.5

(57) ABSTRACT

The present invention provides a connection component and a backlight module. The backlight module is provided with elastic hooks on a first surface of the housing, and the elastic hooks are tightly engaged in a second surface of the back plate, so that it only needs to form the openings on the back plate without punching or riveting to form thread stubs. Thus, the module size will not be affected. During installation of the backlight module, it only needs to slightly provide an external force to engage the elastic hooks into the openings without special installation procedure.

### FIELD OF THE INVENTION

The present invention relates to the field of a backlight module of a liquid crystal display, and more particularly to a connection component and a backlight module having the connection component.

### BACKGROUND OF THE INVENTION

Generally, a structure of a liquid crystal display (LCD) module comprises a frame, glass plates and backlight components, wherein a housing and a back plate of the backlight components are connected to each other by screws or external hooks.

FIG. 1 is a schematic view of the screwing connection between the frame and the back plate, and comprises a back plate 11, a housing 12 and screws 13. The back plate 11 and the housing 12 are provided with inner thread holes 110 and 120, respectively. The screws 13 pass through the holes 110 and 120, so as to connect the back plate 11 with the housing 12. The screwing connection is the most common connection of traditional technologies, but the disadvantages thereof are that the back plate 11 still needs to be punched to form or riveted with thread stubs, while the use of the screws increases the cost of material and the time of installation.

FIG. 2 is a schematic view of the external opening connection therebetween, and comprises a back plate 21 and a housing 22. A bottom of the side of the housing 22 is provided with an elastic engagement hook 220, while the same side of the back plate 21 is provided with a projection 210 corresponding to the elastic engagement hook 220. In assembly, under an external force, the elastic engagement hook 220 can be tightly engaged with the projection 210 by an elastic force itself, so as to connect the back plate 21 with the housing 22. However, the disadvantage of this connection is that it inevitably affects the external dimensions of the module size, i.e. to increase a thickness of at least one housing.

### SUMMARY OF THE INVENTION

The technological problem that the present invention wants to solve is to provide a connection component and a backlight module, which will not affect the module size and can save the cost of material and the time of installation.

To solve the foregoing technological problem, the present invention provides a connection component which comprises a housing and a back plate, wherein the housing has a first surface, and the back plate has a second surface, the first surface is corresponding to the second surface, the first surface is provided with a plurality of engagement elements, each of which comprises a projection projected from the first surface, and one distal end of each of the projection is formed with a plurality of elastic hooks radially distributed outward; wherein the second surface is formed with openings corresponding to the engagement elements. Thus, the projections of the engagement elements can pass through the openings, and then the elastic hooks are tightly engaged with edges of the openings, so that the first surface of the housing and the second surface of the back plate are connected to each other.

As a selectable technical solution, the projection of the engagement element projected from the first surface is a plurality of support rods perpendicular to the first surface, and one distal end of each of the support rods is formed with one of the elastic hooks.

As a selectable technical solution, each of the projection of the engagement element projected from the first surface is a support rod, and one distal end of the support rod is formed with the plurality of elastic hooks, wherein the support rod is a central hollow elastic rod.

The present invention further provides a backlight module which comprises a housing, a back plate and at least one backlight source, wherein the housing has a first surface, and the back plate has a second surface, the first surface is corresponding to the second surface, the housing and the back plate commonly define an inner space for receiving the backlight source, wherein the first surface is provided with a plurality of engagement elements, each of the engagement elements comprises a projection projected from the first surface, and one distal end of each of the projection is formed with a plurality of elastic hooks radially distributed outward; wherein the second surface is formed with openings corresponding to the engagement elements. Thus, the projections of the engagement elements can pass through the openings, and then the elastic hooks are tightly engaged with edges of the openings, so that the housing having the first surface and the back plate having the second surface are connected to each other.

As a selectable technical solution, the housing is a multi-piece type housing, and the housing is provided with the plurality of engagement elements on at least two opposite side components thereof.

As a selectable technical solution, the housing is a one-piece type housing, and the housing is provided with the plurality of engagement elements on at least two opposite sides thereof.

The advantages of the present invention are that: the first surface of the housing is provided with the elastic hooks and the elastic hooks are tightly engaged in the second surface of the back plate, so that it only needs to form the openings on the back plate without punching the back plate to form thread stubs or riveting the back plate with thread stubs. Thus, the module size will not be affected. During installation of the backlight module, it only needs to slightly provide an external force to engage the elastic hooks into the openings without special installation procedure.

### DESCRIPTION OF THE DRAWINGS

FIG. 1 and FIG. 2 are schematic views of the structure of a traditional connection component of traditional technology;

FIG. 3 is a schematic view of the structure of a connection component according to a preferred embodiment of the present invention;

FIG. 4 is a partially enlarged view of an engagement element of the connection component of FIG. 3;

FIG. 5 is an assembled view of a backlight module having the connection component of FIG. 3;

FIG. 6 is a schematic view of the structure of an engagement element according to another preferred embodiment of the present invention; and

FIG. 7 is a schematic view of the structure of an engagement element according to still another preferred embodiment of the present invention.

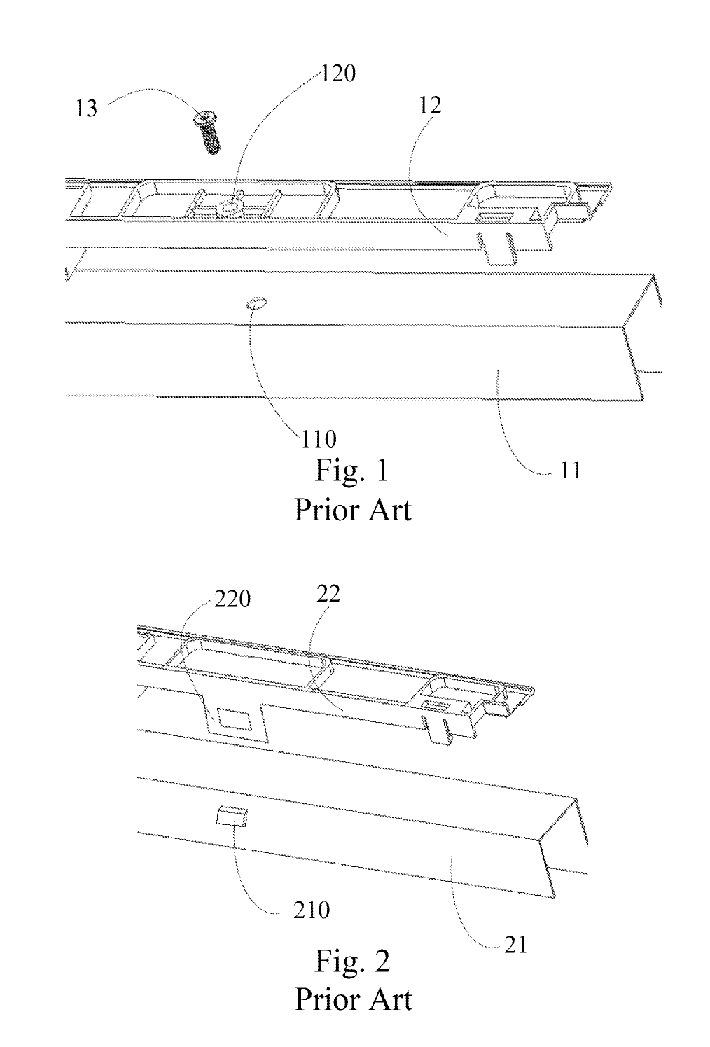

### DETAILED DESCRIPTION OF THE PREFERRED EMBODIMENTS

A preferred embodiment of a connection component and a backlight module having the connection component adopted by the present invention will be described more detailed by referring to the accompanying drawings.

Firstly, referring to the accompanying drawings, a first embodiment of the present invention is provided.

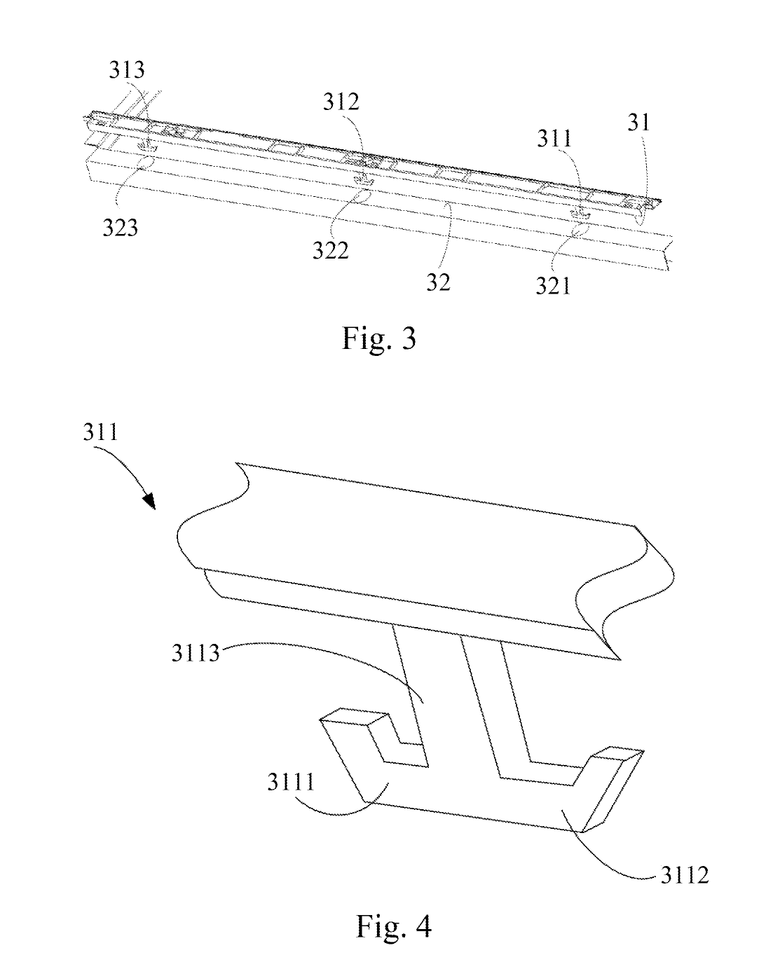

FIG. 3 is a schematic view of the structure of a connection component according to a preferred embodiment of the present invention, and comprises a first surface 31 and a second surface 32 corresponding to each other. The first surface 31 is provided with three engagement elements which are designated by numeral 311, 312 and 313, respectively. The second surface 32 is formed with openings 321, 322 and 323 corresponding to the engagement elements. Thus, the engagement elements 311, 312 and 313 can pass through the corresponding openings 321, 322 and 323, and then be tightly engaged with edges of the openings 321, 322 and 323, so that the first surface 31 and the second surface 32 can be connected to each other. In other embodiments, more or fewer engagement elements also can be provided, and a number of openings are correspondingly provided according to the position of the engagement elements.

Concretely, FIG. 4 is a partially enlarged view of the engagement element 311 of FIG. 3, wherein the engagement element 311 comprises a projection 3113, a first elastic hook 3111 formed on a distal end of the projection 3113 and a second elastic hook 3112 formed on the distal end of the projection 3113. In the embodiment, the projection 3113 is a support rod. In FIG. 4, two sides of the distal end of the projection 3113 are symmetrically formed with two elastic hooks 3111 and 3112. The other two engagement elements 312 and 313 in FIG. 3 also have the same structure. In other embodiments, the distal end of any one or more projection can be further provided with more than two elastic hooks, such as three, four and etc. The plurality of elastic hooks are radially distributed outward in relation to a center defined by the distal end of the projection formed with the elastic hooks. For example, one embodiment can provide three elastic hooks which are three hooks arranged on three positions of 120 degree and radially distributed outward, and another embodiment can provide four elastic hooks which are four hooks arranged on four positions of 90 degree and radially distributed outward. The foregoing central symmetry can even the force between the elastic hooks and the openings when the elastic hooks are tightly engaged with the openings.

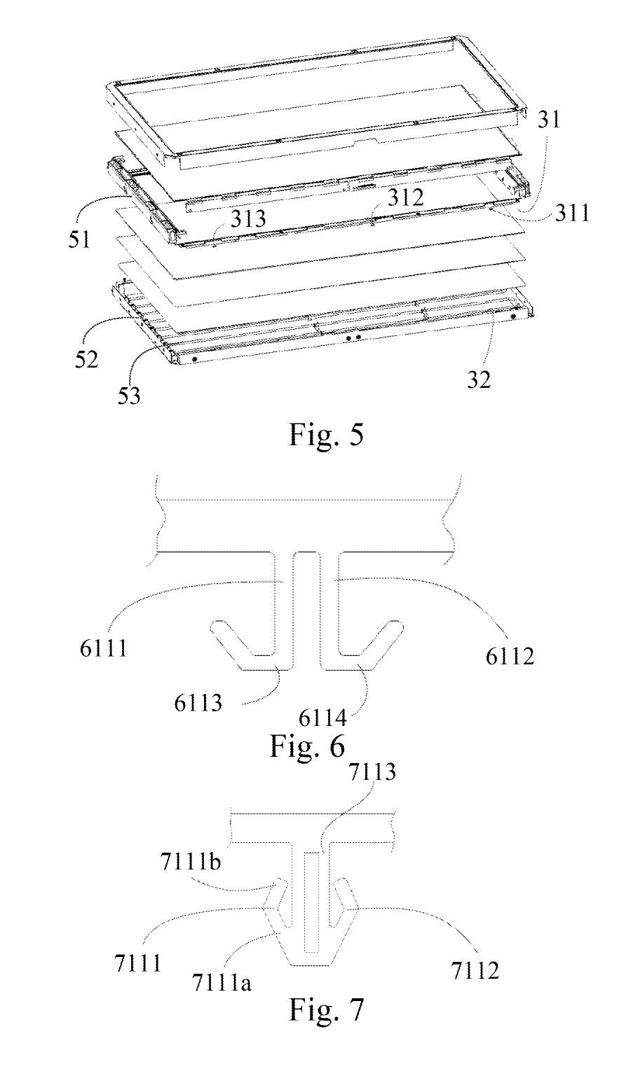

FIG. 5 is an assembled view of a backlight module having the connection component of FIG. 3, and comprises a housing 51, a back plate 52 and a backlight source 53, wherein the housing 51 is generally processed by injection molding of plastic material, while the back plate 52 is generally formed by punching and bending metal material. The housing 51 and the back plate 52 commonly define an inner space to receive at least one of the backlight source 53, at least one optical film or other existing components. In the present invention the housing 51 has a first surface 31, while the back plate 52 has a second surface 32. The first surface 31 is provided with three engagement elements, which are designated by numeral 311, 312 and 313, respectively. The second surface 32 is formed with openings 321-323 corresponding to the engagement elements (the size of the openings are too small and thus not shown in FIG. 5, but the detailed positions thereof are shown in FIG. 3). The housing 51 can be a multi-piece type housing, but also can be a one-piece type housing. In the embodiment, the housing 51 is a multi-piece type housing, and the housing 51 is provided with the plurality of engagement elements 311-313 on at least two opposite side components thereof. If the housing 51 is a one-piece type housing, and the housing is provided with the plurality of engagement elements 311-313 on at least two opposite sides thereof. In addition, the other side (component) of the housing 51 opposite to the side (component) provided with the engagement elements 311-313 is also provided with the same engagement elements (not shown in FIG. 5), while the corresponding positions of the back plate 52 are formed with the same openings 321-323.

In assembly, the engagement elements 311-313 can pass through the openings 321-323, and then the elastic hooks are tightly engaged with edges of the openings. Thus, the housing 51 having the first surface 31 and the back plate 52 having the second surface 32 are connected to each other. As shown in FIG. 5, because the first surface 31 of the housing 51 is provided with the engagement elements 311-313 having the elastic hooks and the elastic hooks on the distal end of the engagement elements 311-313 are tightly engaged in the second surface 32 of the back plate 52, it only needs to form the openings on the back plate 52 without punching the back plate to form thread stubs or riveting the back plate with thread stubs. Thus, the module size of the present invention will not be affected. During installation of the backlight module, it only needs to slightly provide an external force to engage the engagement elements 311-313 into the openings without special installation procedure or additional screwing components.

FIG. 6 is a schematic view of the structure of an engagement element according to another preferred embodiment of the present invention, and comprises a first support rod 6111 and a second support rod 6112, both of which are vertical to the first surface. A distal end of the first support rod 6111 has a first elastic hook 6113, while a distal end of the second support rod 6112 has a second elastic hook 6114. The first elastic hook 6113 and the second elastic hook 6114 commonly define an included angle of 180 degree on a common plane. In other embodiments similar to FIG. 6, the engagement element can have more support rods, such as three, four and etc., all of which are symmetrically arranged to form a triple or quadruple arrangement. A distal end of each of the support rods has an elastic hook. For example, one embodiment can provide three support rods and three elastic hooks, wherein the three elastic hooks are arranged on three positions of 120 degree and radially distributed outward, and another embodiment can provide four support rods and four elastic hooks, wherein the four elastic hooks are arranged on four positions of 90 degree and radially distributed outward.

FIG. 7 is a schematic view of the structure of an engagement element according to still another preferred embodiment of the present invention, wherein the portion of the projection is a central hollow elastic rod 7113. A distal end of the elastic rod 7113 is provided with a first elastic hook 7111 and a second elastic hook 7112. The advantage of the central hollow elastic rod 7113 is that the central hollow structure thereof can increase the compression range of the engagement element along a direction parallel to the first surface, and thus it is easier for the first elastic hook 7111 and the second elastic hook 7112 to be engaged into the corresponding openings (not shown in FIG. 7). The first elastic hook 7111 comprises an elastic connection arm 7111a and a hook portion 7111b, wherein the connection arm 7111a is connected to the elastic rod 7113, and an included angle therebetween is smaller than 90 degree; and wherein the hook portion 7111b is connected to the connection arm 7111a, and an included angle therebetween is greater than 90 degree. Thus, a connection portion between the hook portion 7111b and the connection arm 7111a is formed with a projection projected outward and away from the elastic rod 7113. The second elastic hook 7112 has a similar structure. The foregoing projections can ensure that it is convenient to install and detach the engagement element having the elastic hooks. Of course, similar to the foregoing embodiment, the distal end of the elastic rod 7113 also can be provided with more than two elastic hooks, such as three, four and etc., wherein the arrangement and advantage thereof can refer to the foregoing description without repeating.

The present invention has been described with a preferred embodiment thereof and it is understood that many changes and modifications to the described embodiment can be carried out without departing from the scope and the spirit of the invention that is intended to be limited only by the appended claims.

1. A backlight module, comprising: a housing, a back plate and at least one backlight source, the housing having a first surface, and the back plate having a second surface, the first surface being corresponding to the second surface, the housing and the back plate commonly defining an inner space for receiving the backlight source, characterized in that:
the first surface is provided with a plurality of engagement elements, each of the engagement elements comprises a projection projected from the first surface, and one distal end of each of the projection is formed with a plurality of elastic hooks radially distributed outward;
the second surface is formed with openings corresponding to the engagement elements, the projections of the engagement elements pass through the openings, and then the elastic hooks are tightly engaged with edges of the openings, so that the housing having the first surface and the back plate having the second surface are connected to each other;
wherein each of the projection of the engagement element projected from the first surface is a support rod, one distal end of the support rod is formed with the plurality of elastic hooks, and the support rod is a central hollow elastic rod;
wherein each of the elastic hooks comprises a connection arm and a hook portion, the connection arm is connected to the elastic rod, and an included angle therebetween is smaller than 90 degree; and
wherein the hook portion is connected to the connection arm, and an included angle therebetween is greater than 90 degree;
wherein the housing is a multi-piece type housing, and the housing is provided with the plurality of engagement elements on at least two opposite side components thereof.

2. A connection component, comprising: a housing and a back plate, the housing having a first surface, and the back plate having a second surface, the first surface being corresponding to the second surface, characterized in that:
the first surface is provided with a plurality of engagement elements, each of the engagement elements comprises a projection projected from the first surface, and one distal end of each of the projection is formed with a plurality of elastic hooks radially distributed outward;
the second surface is formed with openings corresponding to the engagement elements, the projections of the engagement elements pass through the openings, and then the elastic hooks are tightly engaged with edges of the openings, so that the first surface of the housing and the second surface of the back plate are connected to each other.

3. The connection component according to claim 2, characterized in that: the projection of the engagement element projected from the first surface is a plurality of support rods perpendicular to the first surface, and one distal end of each of the support rods is formed with one of the elastic hooks.

4. The connection component according to claim 2, characterized in that: each of the projection of the engagement element projected from the first surface is a support rod, and one distal end of the support rod is formed with the plurality of elastic hooks.

5. The connection component according to claim 4, characterized in that: the support rod is a central hollow elastic rod.

6. The connection component according to claim 2, characterized in that: each of the elastic hooks comprises a connection arm and a hook portion, the connection arm is connected to the elastic rod, and an included angle therebetween is smaller than 90 degree; and wherein the hook portion is connected to the connection arm, and an included angle therebetween is greater than 90 degree.

7. A backlight module, comprising: a housing, a back plate and at least one backlight source, the housing having a first surface, and the back plate having a second surface, the first surface being corresponding to the second surface, the housing and the back plate commonly defining an inner space for receiving the backlight source, characterized in that:
the first surface is provided with a plurality of engagement elements, each of the engagement elements comprises a projection projected from the first surface, and one distal end of each of the projection is formed with a plurality of elastic hooks radially distributed outward;
the second surface is formed with openings corresponding to the engagement elements, the projections of the engagement elements pass through the openings, and then the elastic hooks are tightly engaged with edges of the openings, so that the housing having the first surface and the back plate having the second surface are connected to each other;

8. The backlight module according to claim 7, characterized in that: the projection of the engagement element projected from the first surface is a plurality of support rods perpendicular to the first surface, and one distal end of each of the support rods is formed with one of the elastic hooks.

9. The backlight module according to claim 7, characterized in that: each of the projection of the engagement element projected from the first surface is a support rod, and one distal end of the support rod is formed with the plurality of elastic hooks.

10. The backlight module according to claim 9, characterized in that: the support rod is a central hollow elastic rod.

11. The connection component according to claim 7, characterized in that: each of the elastic hooks comprises a connection arm and a hook portion, the connection arm is connected to the elastic rod, and an included angle therebetween is smaller than 90 degree; and wherein the hook portion is connected to the connection arm, and an included angle therebetween is greater than 90 degree.

12. The backlight module according to claim 7, characterized in that: the housing is a multi-piece type housing, and the housing is provided with the plurality of engagement elements on at least two opposite side components thereof.

13. The backlight module according to claim 7, characterized in that: the housing is a one-piece type housing, and the housing is provided with the plurality of engagement elements on at least two opposite sides thereof.
